(19) United States
(12) Patent Application Publication
(10) Pub. No.: US 2023/0282934 A1
(43) Pub. Date: Sep. 7, 2023

(54) NONAQUEOUS ELECTROLYTE SECONDARY BATTERY SEPARATOR, NONAQUEOUS ELECTROLYTE SECONDARY BATTERY MEMBER, AND NONAQUEOUS ELECTROLYTE SECONDARY BATTERY

(71) Applicant: Sumitomo Chemical Company, Limited, Tokyo (JP)

(72) Inventors: Riku MATSUMINE, Niihama-shi (JP); Akihiko SHIN, Niihama-shi (JP)

(21) Appl. No.: 18/117,161

(22) Filed: Mar. 3, 2023

(30) Foreign Application Priority Data
Mar. 4, 2022 (JP) 2022-033935

(51) Int. Cl. H01M 50/423; H01M 50/417; H01M 50/449; H01M 50/489

(52) U.S. Cl. CPC H01M 50/423; H01M 50/417; H01M 50/449; H01M 50/489

(57) ABSTRACT

As a nonaqueous electrolyte secondary battery separator which has excellent heat resistance and excellent voltage withstand characteristics, provided is a separator including a mixed layer which contains a heat-resistant resin and a porous base material that includes a polyolefin porous film. When attenuated total reflection infrared spectroscopy is carried out with respect to an opposite surface of the separator, a ratio between an intensity of a peak indicating the heat-resistant resin and an intensity of a peak indicating the polyolefin-based resin is not less than 0.02.

This Nonprovisional application claims priority under 35 U.S.C. §119 on Patent Application No. 2022-033935 filed in Japan on Mar. 4, 2022, the entire contents of which are hereby incorporated by reference.

### TECHNICAL FIELD

The present invention relates to a separator for a nonaqueous electrolyte secondary battery (hereinafter referred to as a “nonaqueous electrolyte secondary battery separator”), a member for a nonaqueous electrolyte secondary battery (hereinafter referred to as a “nonaqueous electrolyte secondary battery member”), and a nonaqueous electrolyte secondary battery.

### BACKGROUND ART

Nonaqueous electrolyte secondary batteries such as lithium secondary batteries are currently in wide use as (i) batteries for devices such as personal computers, mobile telephones, and portable information terminals or (ii) on-vehicle batteries.

As separators for the nonaqueous electrolyte secondary batteries, known are separators the heat resistance of each of which is improved by causing a part of a resin, which constitutes a heat-resistant layer formed on a porous film containing polyolefin as a main component, to penetrate into a part of the porous film (for example, Patent Literatures 1 to 3).

### CITATION LIST

### [Patent Literature]

### [Patent Literature 1]

Published Japanese Translation of PCT International Application Tokuhyo No. 2013-511818

### [Patent Literature 2]

Japanese Patent Application Publication Tokukai No.

### [Patent Literature 3]

Pamphlet of PCT International Publication No. WO 2019/107219

### SUMMARY OF INVENTION

### Technical Problem

However, in each of the above conventional separators, a degree of penetration of the resin, which constitutes the heat-resistant layer, into the porous film is suppressed, from the viewpoint of ensuring a good shutdown characteristic and preventing an excessive increase in resistance. Therefore, the conventional separators each have a problem that the heat resistance is insufficient particularly in a region in which a weight per unit area is low and a problem that there is room for improvement in safety. Furthermore, in each of the conventional separators, there is also room for improvement in voltage withstand characteristics.

The object of an aspect of the present invention is to provide a nonaqueous electrolyte secondary battery separator which has more excellent heat resistance and more excellent voltage withstand characteristics than conventional separators.

### Solution to Problem

The inventors of the present invention found that, by causing the resin, which constitutes the heat-resistant layer, to penetrate into the substantially entire porous film, the heat resistance can be more improved and also excellent voltage withstand characteristics can be achieved. As a result, the inventors of the present invention conceived of the present invention.

The present invention includes the following aspects <1> to <9>.

<1> A nonaqueous electrolyte secondary battery separator including
a mixed layer which contains a heat-resistant resin and a porous base material that includes a porous film containing a polyolefin-based resin as a main component,
when attenuated total reflection infrared spectroscopy (ATR-IR) is carried out with respect to an opposite surface of the nonaqueous electrolyte secondary battery separator, a peak indicating the polyolefin-based resin and a peak indicating the heat-resistant resin being observed, and a ratio (A/B) between an intensity (A) of the peak indicating the heat-resistant resin and an intensity (B) of the peak indicating the polyolefin-based resin being not less than 0.02.

<2> The nonaqueous electrolyte secondary battery separator described in <1>, wherein:
the peak indicating the heat-resistant resin is a peak present in 1,620 cm⁻¹ to 1,700 cm⁻¹; and the peak indicating the polyolefin-based resin is a peak present in 1,400 cm⁻¹ to 1,500 cm⁻¹.

<3> The nonaqueous electrolyte secondary battery separator described in <1>or <2>, wherein a heat-resistant layer which contains the heat-resistant resin is formed on the mixed layer.

<4> The nonaqueous electrolyte secondary battery separator described in <3>, wherein the heat-resistant layer further contains a filler.

<5> The nonaqueous electrolyte secondary battery separator described in <4>, wherein an amount of the filler contained in the heat-resistant layer is not less than 20% by weight and not more than 90% by weight, relative to a total weight of the heat-resistant layer.

<6> The nonaqueous electrolyte secondary battery separator described in any one of <1>to <5>, wherein an air permeability of the nonaqueous electrolyte secondary battery separator is not more than 500 sec/100 mL.

<7> The nonaqueous electrolyte secondary battery separator described in any one of <1>to <6>, wherein the heat-resistant resin is an aramid resin.

<8> A nonaqueous electrolyte secondary battery member comprising:
a positive electrode;
a nonaqueous electrolyte secondary battery separator described in any one of <1>to <7>; and
a negative electrode,
the positive electrode, the nonaqueous electrolyte secondary battery separator, and the negative electrode being disposed in this order.

<9>A nonaqueous electrolyte secondary battery comprising a nonaqueous electrolyte secondary battery separator described in any one of <1>to <7>.

### Advantageous Effects of Invention

A nonaqueous electrolyte secondary battery separator in accordance with an embodiment of the present invention has the effect of having more excellent heat resistance and also more excellent voltage withstand characteristics than conventional separators.

### DESCRIPTION OF EMBODIMENTS

The following description will discuss embodiments of the present invention. Note, however, that the present invention is not limited to the embodiments. The present invention is not limited to arrangements described below, but may be altered in various ways by a skilled person within the scope of the claims. The present invention also encompasses, in its technical scope, any embodiment derived by combining technical means disclosed in differing embodiments. Note that any numerical range expressed as “A to B” herein means “not less than A and not more than B” unless otherwise stated.

Herein, the term “machine direction” (MD) refers to a direction in which a polyolefin resin composition in sheet form and a porous film are conveyed in the below-described method of producing a porous film. The term “transverse direction” (TD) refers to a direction which is (i) perpendicular to the MD and (ii) parallel to a surface of the polyolefin resin composition in sheet form and a surface of the porous film.

### EMBODIMENT 1

### Nonaqueous Electrolyte Secondary Battery Separator

A nonaqueous electrolyte secondary battery separator in accordance with an embodiment of the present invention (hereinafter simply referred to as “separator”) includes a mixed layer which contains a heat-resistant resin and a porous base material that includes a porous film containing a polyolefin-based resin as a main component. In the separator, when attenuated total reflection infrared spectroscopy (ATR-IR) is carried out with respect to an opposite surface of the nonaqueous electrolyte secondary battery separator, a peak indicating the polyolefin-based resin and a peak indicating the heat-resistant resin are observed, and a ratio (A/B: hereinafter referred to as “peak intensity ratio”) between an intensity (A) of the peak indicating the heat-resistant resin and an intensity (B) of the peak indicating the polyolefin-based resin is not less than 0.02. The characteristics of the separator and members constituting the separator will be described below.

The “mixed layer” can be formed, for example, by causing the heat-resistant resin to penetrate into the porous base material through one surface out of surfaces of the porous base material. For example, when the heat-resistant resin is caused to penetrate into a part of the porous base material, the separator has the mixed layer and a part which is constituted only by the porous base material. Herein, the “part which is constituted only by the porous base material” of the separator is referred to as “residual porous base material”.

The “opposite surface of the nonaqueous electrolyte secondary battery separator” is a surface which is located on a lower side when the nonaqueous electrolyte secondary battery separator is placed on a horizontal surface (surface in contact with the horizontal surface). The “opposite surface” when the heat-resistant resin has been caused to penetrate into a part of the porous base material is an opposite surface of the residual porous base material. The opposite surface of the residual porous base material is a surface which faces an upper surface of the mixed layer, i.e., out of the surfaces of the porous base material, a surface that faces a surface through which penetration of the heat-resistant resin has been started.

On the other hand, for example, when the heat-resistant resin is caused to penetrate into all the parts of the porous base material, the separator has the mixed layer and does not have the residual porous base material. In this case, the “opposite surface of the nonaqueous electrolyte secondary battery separator” is an opposite surface of the mixed layer. Namely, the opposite surface is, out of the surfaces of the porous base material, a surface that faces a surface through which penetration of the heat-resistant resin has been started.

Note that when the nonaqueous electrolyte secondary battery separator includes a heat-resistant layer (described later), the “opposite surface of the nonaqueous electrolyte secondary battery separator” is a surface that is located on a side on which the heat-resistant layer is not present, out of surfaces of the nonaqueous electrolyte secondary battery separator except surfaces (side surfaces) which form the thickness of the nonaqueous electrolyte secondary battery separator.

Note, here, that ATR-IR is a method of measuring the composition of a measurement surface and its vicinity (typically, a part ranging from the measurement surface to a depth of 3 μm from the measurement surface) by obtaining an infrared reflection spectrum of the measurement surface and its vicinity. When the heat-resistant resin is caused to penetrate into the porous base material through one surface of the porous base material, the penetration of the heat-resistant resin progresses from a surface through which the heat-resistant resin is caused to penetrate into the porous base material toward a surface which is opposite to the surface (the above-described opposite surface).

In the separator, the penetration of the heat-resistant resin progresses to an entire or substantially entire region of the porous base material to such a degree that the separator exhibits the above peak intensity ratio in a region of the opposite surface and its vicinity.

Therefore, in the separator, the heat resistance of the porous base material is improved. It is considered that, in the separator, the heat-resistant resin enters a void in the porous base material. It is assumed that this causes a pore structure of the porous base material to be densified and therefore the pore structure is unlikely to be collapsed even when an excessive voltage is applied to the porous base material. Thus, it is considered that the separator has excellent voltage withstand characteristics.

In the separator, the “peak intensity ratio” is not less than 0.02, preferably not less than 0.025, and more preferably not less than 0.029. The “peak intensity ratio” of not less than 0.02 means that the heat-resistant resin is contained in a suitable amount in a substantially entire region of the separator. As a result, the heat resistance and the voltage withstand characteristics of the separator are more improved.

When ATR-IR is carried out with respect to the opposite surface of the separator, the “peak intensity ratio” is preferably not more than 0.1, and more preferably not more than 0.05.

As described later, the heat-resistant resin is preferably an aramid resin having an amide bond. The polyolefin-based resin constituting the porous base material is preferably polyethylene. It is known that a peak derived from an amide bond of an aramid resin is present in 1,620 cm⁻¹ to 1,700 cm⁻¹, and a peak derived from polyethylene is present in 1,400 cm⁻to 1,500 cm⁻¹. Thus, in an embodiment of the present invention, the peak indicating the heat-resistant resin is preferably a peak present in 1,620 cm⁻¹ to 1,700 cm⁻¹, and the peak indicating the polyolefin-based resin is preferably a peak present in 1,400 cm⁻¹ to 1,500 cm⁻¹.

In an embodiment of the present invention, a measurement method and measurement conditions in ATR-IR are not limited to any particular ones, provided that an IR spectrum can be obtained in which the peak indicating the polyolefin-based resin and the peak indicating the heat-resistant resin can be observed and peak intensities of these peaks can be measured. For example, measurement in the ATR-IR can be carried out with use of a commercially available IR measurement device. Note, here, that values of the above two peak intensities can vary depending on the measurement method and the measurement conditions. However, the values of the two peak intensities are identical in degree of the variation. Therefore, even when the measurement method and the measurement conditions vary, a value of the ratio (A/B) does not vary.

### [Porous Base Material]

The porous base material in an embodiment of the present invention will be described below. Note that the mere term “porous base material” means a porous base material which does not contain a heat-resistant resin.

The porous base material includes a polyolefin porous film. Note that the polyolefin porous film is a porous film which contains a polyolefin-based resin as a main component. Note that the phrase “contains a polyolefin-based resin as a main component” means that the porous film contains the polyolefin-based resin at a proportion of not less than 50% by volume, preferably not less than 90% by volume, and more preferably not less than 95% by volume, relative to the total volume of materials of which the porous film is made.

The porous base material has therein many pores connected to one another. This allows a gas and a liquid to pass through the porous base material from one side to the other side.

The porous base material has a thickness of preferably 5 μm to 20 pm, more preferably 7 μm to 15 μm, and still more preferably 8 μm to 15 μm. The porous base material having a thickness of not less than 5 μm can sufficiently have functions (such as a shutdown function) which the separator is required to have. The porous base material having a thickness of not more than 20 μm allows the separator to be thinner.

The polyolefin-based resin more preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000, because the strength of each of the obtained porous base material and the nonaqueous electrolyte secondary battery separator including the porous base material is improved.

The polyolefin-based resin is not limited to any particular one. Examples of the polyolefin-based resin can include: homopolymers which are each obtained by polymerizing a single monomer selected from monomers such as ethylene, propylene, 1-butene, 4-methyl-1-pentene, and 1-hexene; and copolymers which are each obtained by polymerizing two or more monomers selected from such monomers.

Examples of the homopolymers include polyethylene, polypropylene, and polybutene. Examples of the copolymers include an ethylene-propylene copolymer.

As the polyolefin-based resin, polyethylene is more preferable. Examples of the polyethylene include low-density polyethylene, high-density polyethylene, linear polyethylene (ethylene-a-olefin copolymer), and ultra-high molecular weight polyethylene having a weight-average molecular weight of not less than 1,000,000. Among these examples, ultra-high molecular weight polyethylene having a weight-average molecular weight of not less than 1,000,000 is still more preferable.

The porous base material typically has a weight per unit area of preferably 2 g/m² to 20 g/m², and more preferably 5 g/m² to 12 g/m² so as to allow a battery to have a high weight energy density and a high volume energy density.

The porous base material has an air permeability of preferably 30 sec/100 mL to 500 sec/100 mL, and more preferably 50 sec/100 mL to 300 sec/100 mL, in terms of a Gurley value, from the viewpoint of exhibiting sufficient ion permeability.

The porous base material has a porosity of preferably 20% by volume to 80% by volume, and more preferably 30% by volume to 75% by volume, so as to (i) retain an increased amount of an electrolyte and (ii) obtain the function of reliably preventing (shutting down) a flow of an excessively large electric current at a lower temperature.

The pores in the porous base material each have a pore diameter of preferably not more than 0.1 μm and more preferably not more than 0.06 μm, from the viewpoint of achieving sufficient ion permeability and preventing particles which constitute an electrode from entering the pores.

### [Method of Producing Porous Base Material]

In an embodiment of the present invention, a method of producing the porous base material is not limited to particular one, and any publicly known method can be employed. For example, as disclosed in Japanese Patent No. 5476844, a method can be employed which involves adding a filler to a thermoplastic resin, forming a resulting mixture into a film, and then removing the filler.

Specifically, when, for example, the polyolefin porous film is made of the polyolefin-based resin which contains an ultra-high molecular weight polyethylene and a low molecular weight polyolefin that has a weight-average molecular weight of not more than 10,000, the porous base material is preferably produced by, from the viewpoint of production costs, a method including the following steps (1) through (4):

(1) kneading 100 parts by weight of an ultra-high molecular weight polyethylene, 5 parts by weight to 200 parts by weight of a low molecular weight polyolefin which has a weight-average molecular weight of not more than 10,000, and 100 parts by weight to 400 parts by weight of an inorganic filler such as calcium carbonate to obtain a polyolefin-based resin composition;

(2) forming the polyolefin-based resin composition into a sheet;

(3) removing the inorganic filler from the sheet obtained in the step (2); and

(4) stretching the sheet obtained in the step (3).

Alternatively, the porous base material may be produced by a method disclosed in any of the above-listed Patent Literatures.

The polyolefin porous film may be alternatively a commercially available product which has the above-described characteristics.

### [Mixed Layer]

The mixed layer in an embodiment of the present invention is a layer which contains the porous base material and the heat-resistant resin. Thus, the mixed layer contains the heat-resistant resin and the polyolefin-based resin which is a component that constitutes the porous base material.

In an embodiment of the present invention, the entire porous base material may be contained in the mixed layer or alternatively a part of the porous base material may be contained in the mixed layer. Specifically, the separator may or may not include the residual porous base material. The mixed layer can be formed by causing the heat-resistant resin to penetrate into the porous base material through one surface of the porous base material (described later). Note, here, that, for example, the separator can have (i) the mixed layer on a side on which the one surface of the porous base material, through which the heat-resistant resin has been caused to penetrate into the porous base material, is located and (ii) the residual porous base material on a side which faces the side.

In an embodiment of the present invention, the heat-resistant resin is contained to such a degree that the peak intensity ratio is not less than 0.02 at least in a region ranging from the upper surface of the mixed layer to a depth (for example, 3 μm) from the opposite surface of the separator to which depth measurement by ATR-IR can be carried out.

The percent by volume of the mixed layer is represented by a proportion of the volume of the part of the porous base material which is contained in the mixed layer, relative to the total volume of the porous base material. The percent by volume of the mixed layer is preferably not less than 5.0% by volume, and more preferably not less than 7.0% by volume, relative to the total volume of the porous base material, from the viewpoint of improving the heat resistance and the voltage withstand characteristics of the separator. The upper limit of the volume of the mixed layer is 100% by volume, preferably not more than 55% by volume, and more preferably not more than 40% by volume, relative to the total volume of the porous base material.

The heat-resistant resin is a resin which has more excellent heat resistance than the polyolefin. In an embodiment of the present invention, the separator has the mixed layer. Therefore, it is possible to improve the heat resistance and the voltage withstand characteristics of the separator.

It is preferable that the heat-resistant resin be insoluble in an electrolyte of a battery and be electrochemically stable when the battery is in normal use.

Examples of the heat-resistant resin include nitrogen-containing aromatic polymers; (meth)acrylate-based resins;

fluorine-containing resins; polyester-based resins; rubbers; resins having a melting point or a glass transition temperature of not lower than 180° C.; water-soluble polymers; and polycarbonate, polyacetal, and polyether ether ketone.

Examples of the nitrogen-containing aromatic polymers include aromatic polyamide, aromatic polyimide, aromatic polyamide imide, polybenzimidazole, polyurethane, and melamine resin. Examples of the aromatic polyamide include wholly aromatic polyamide (aramid resin) and semi-aromatic polyamide. Examples of the aromatic polyamide include para-aramid and meta-aramid. Among the above nitrogen-containing aromatic polymers, wholly aromatic polyamide is preferable, and para-aramid is more preferable.

Herein, “para-aramid” indicates wholly aromatic polyamide in which amide bonds are present at para positions or quasi-para positions of aromatic rings. Note that “quasi-para positions” indicate positions which are located on opposite sides of aromatic rings and which are located coaxially or in parallel to each other. Examples of such positions include positions 4 and 4′ of a biphenylene ring, positions 1 and 5 of a naphthalene ring, and positions 2 and 6 of a naphthalene ring.

Specific examples of the para-aramid include poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and a paraphenylene terephthalamide/2,6-dichloroparaphenylene terephthalamide copolymer. Among the above examples of the para-aramid, poly(paraphenylene terephthalamide) is preferable because poly(paraphenylene terephthalamide) is easy to produce and handle.

Examples of the fluorine-containing resins include polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer. Particular examples of the fluorine-containing resins include fluorine-containing rubber having a glass transition temperature of not higher than 23° C.

Preferable examples of the polyester-based resins include aromatic polyester, such as polyarylate, and liquid crystal polyester.

Examples of the rubbers include a styrene-butadiene copolymer and a hydride thereof, a methacrylate ester copolymer, an acrylonitrile-acrylic ester copolymer, a styrene-acrylic ester copolymer, ethylene propylene rubber, and polyvinyl acetate.

Examples of the resins having a melting point or a glass transition temperature of not lower than 180° C. include polyphenylene ether, polysulfone, polyether sulfone, polyphenylene sulfide, polyetherimide, polyamide imide, and polyether amide.

Examples of the water-soluble polymers include polyvinyl alcohol, polyethylene glycol, cellulose ether, sodium alginate, polyacrylic acid, polyacrylamide, and polymethacrylic acid.

Note that, as the heat-resistant resin, only one type of resin may be used or two or more types of resins may be alternatively used in combination.

The molecular weight of the heat-resistant resin is preferably 1.0 dL/g to 2.5 dL/g, and more preferably 1.2 dL/g to 2.0 dL/g, in terms of an intrinsic viscosity. When the molecular weight of the heat-resistant resin is less than 1.0 dL/g, there is a possibility that improvement in heat resistance of the mixed layer is not seen. When the molecular weight of the heat-resistant resin is more than 2.5 dL/g, the heat-resistant resin does not easily penetrate into the interior of the porous base material.

The weight per unit area, the air permeability, and the porosity of the mixed layer and the pore diameter of pores in the mixed layer preferably fall within the same ranges as the preferable ranges of the weight per unit area, the air permeability, and the porosity of the porous base material and the pore diameter of the pores in the porous base material.

### [Method of Producing Mixed Layer]

In an embodiment of the present invention, the mixed layer can be produced by, for example, the following method. That is, the mixed layer can be produced by a method which involves applying a coating solution containing the heat-resistant resin to one surface of the porous base material, causing the coating solution to penetrate into at least a part of the interior of the porous base material, and then removing a solvent contained in the coating solution.

In so doing, the coating solution may be caused to penetrate into the entire interior of the porous base material or the coating solution may be caused to penetrate into a part of the interior of the porous base material. A case in which the coating solution is caused to penetrate into the entire interior of the porous base material refers to a case in which the residual porous base material is not present. A case in which the coating solution is caused to penetrate into a part of the interior of the porous base material refers to a case in which the residual porous base material is present.

Note, however, that when the coating solution is caused to penetrate into a part of the interior of the porous base material, the following requirement needs to be satisfied. That is, when attenuated total reflection infrared spectroscopy (ATR-IR) is carried out with respect to the opposite surface, the peak indicating the polyolefin-based resin and the peak indicating the heat-resistant resin are observed and the “peak intensity ratio” is not less than 0.02.

It is possible to satisfy the requirement by fulfilling one or more of production conditions (A) to (C) described later in the above method of producing the mixed layer.

Note here that the coating solution which does not penetrate into the interior of the porous base material can form a layer on the mixed layer. By removing the solvent contained in the coating solution, a heat-resistant layer (described later) can be formed on the mixed layer. Thus, the nonaqueous electrolyte secondary battery separator in accordance with an embodiment of the present invention can be configured such that the heat-resistant layer is formed on the mixed layer.

Before the coating solution is applied to one surface of the porous base material, the one surface can be subjected to a hydrophilization treatment as necessary.

The coating solution can contain a filler (described later) which can be contained in the heat-resistant layer. The coating solution can be typically prepared by dissolving the heat-resistant resin in the solvent.

When the heat-resistant layer containing the filler is formed on the mixed layer, the coating solution can be typically prepared by, in addition to dissolving the heat-resistant resin in the solvent, dispersing the filler in the solvent. In this case, the solvent serves also as a dispersion medium for dispersing the filler therein.

The heat-resistant resin may be caused to be an emulsion by the solvent.

The solvent is not limited to any particular one, provided that the solvent (i) does not adversely affect the porous base material, (ii) allows the heat-resistant resin to be uniformly and stably dissolved therein, and (iii) allows the filler to be uniformly and stably dispersed therein when the solvent contains the filler. Examples of the solvent include water and organic solvents. As the solvent, only one type of solvent may be used or two or more types of solvents may be alternatively used in combination.

The coating solution may be formed by any method, provided that the coating solution is capable of satisfying conditions, such as a resin solid content (resin concentration) and a fine particle amount, which are necessary to obtain the mixed layer and the heat-resistant layer. Specific examples of a method of forming the coating solution include a mechanical stirring method, an ultrasonic dispersion method, a high-pressure dispersion method, and a media dispersion method. The coating solution may contain, as a component(s) other than the resin heat-resistant resin and fine particles, an additive(s) such as a disperser, a plasticizer, a surfactant, and/or a pH adjustor, provided that the additive(s) does/do not prevent the object of the present invention from being attained. Note that the additive(s) may be contained in an amount(s) that does/do not prevent the object of the present invention from being attained.

The coating solution can be applied to the porous base material by a conventionally known method. Specific examples of such a method include a gravure coater method, a dip coater method, a bar coater method, and a die coater method.

The solvent is generally removed by a drying method. Note also that drying may be carried out after the solvent contained in the coating solution is replaced with another solvent.

In an embodiment of the present invention, for example, by employing one or more of the following production conditions (A) to (C), it is possible to promote penetration of the coating solution into the interior of the porous base material and suitably produce the mixed layer. As a result, it is possible to cause the “peak intensity ratio” to be not less than 0.02.

(A) When the coating solution is applied to the porous base material, a high-pressure bar is, for example, used so that a working load of preferably not less than 250 N/m, and more preferably not less than 300 N/mm per width of a coating bar is applied to a surface of the porous base material which is to be coated with the coating solution. Note that the working load is calculated as a product of the pressure of the coating solution in a land part (region between an entrance to and an exit from the coating bar for the coating solution) and the solution-wetted area of the land portion.

(B) The solvent is removed by drying in which a drying condition(s) is/are controlled so that a drying time is preferably not shorter than 10 seconds, and more preferably not shorter than 20 seconds.

(C) The amount of the heat-resistant resin contained in the coating solution is controlled to preferably 2.0% by weight to 10.0% by weight, and more preferably 4.5% by weight to 8.0% by weight.

As a method of suppressing the penetration of the heat-resistant resin into the interior of the porous base material, known is an opposite surface impregnation method which involves applying the coating solution to one surface of the porous base material and impregnating, in, for example, a solvent such as NMP, a surface of the porous base material which is opposite to the surface to which the coating solution is applied. In an embodiment of the present invention, the heat-resistant resin may be caused to penetrate into the entire interior of the porous base material, as described above. Therefore, the mixed layer can be suitably produced also by applying the coating solution to one surface of the porous base material without employing a method such as an opposite surface impregnation method. When the heat-resistant resin is caused to penetrate into a part of the interior of the porous base material, the opposite surface impregnation method or the like may be used as appropriate.

### [Heat-Resistant Layer]

As described above, the nonaqueous electrolyte secondary battery separator in accordance with an embodiment of the present invention can include the heat-resistant layer that is formed on the mixed layer.

The heat-resistant layer contains the heat-resistant resin. The heat-resistant layer can also contain the filler. Examples of the filler include organic fine particles and inorganic fine particles. Therefore, when the heat-resistant layer contains the filler, the heat-resistant resin contained in the heat-resistant layer also serves as a binder resin for binding the filler and binding the filler and the mixed layer. The filler is preferably constituted by electrically insulating fine particles. Further, the filler may be a combination of two or more types of fillers which differ from each other in one or more of a constituent material, a particle diameter, and a specific surface area.

Examples of an organic substance which constitutes the organic fine particles include: homopolymers which are each obtained from a monomer selected from monomers such as styrene, vinyl ketone, acrylonitrile, methyl methacrylate, ethyl methacrylate, glycidyl methacrylate, glycidyl acrylate, and methyl acrylate; copolymers which are each obtained from two or more monomers selected from such monomers; fluorine-based resins such as polytetrafluoroethylene, a tetrafluoroethylene-hexafluoropropylene copolymer, a tetrafluoroethylene-ethylene copolymer, and polyvinylidene fluoride; melamine resin; urea resin; polyolefin; and polymethacrylate. As the organic fine particles, one type of organic fine particles may be used or two or more types of organic fine particles may be alternatively used in combination. The organic fine particles are preferably constituted by polytetrafluoroethylene in light of chemical stability.

Examples of an inorganic substance which constitutes the inorganic fine particles include metal oxide, metal nitride, metal carbide, metal hydroxide, carbonate, and sulfate. Specific examples of the inorganic substance include: powders of aluminum oxide (such as alumina), boehmite, silica, titania, magnesia, barium titanate, aluminum hydroxide, calcium carbonate, and the like; and minerals such as mica, zeolite, kaolin, and talc. As the inorganic fine particles, one type of inorganic fine particles may be used or two or more types of inorganic fine particles may be alternatively used in combination. The inorganic fine particles are preferably constituted by aluminum oxide in light of chemical stability.

The particles of the filler can each have a substantially spherical shape, a plate shape, a columnar shape, a needle shape, a whisker shape, a fibrous shape, or the like. The particles can each have any shape. The filler is preferably constituted by substantially spherical particles, because such particles facilitate formation of uniform pores.

The average particle diameter of the filler is preferably 0.01 μm to 1 μm. Herein, the “average particle diameter of the filler” indicates a volume-based average particle diameter (D50) of the filler. The “D50” means a particle diameter having a value at which a cumulative value reaches 50% in a volume-based particle size distribution. The D50 can be measured with use of, for example, a laser diffraction particle size analyzer (product names: SALD2200, SALD2300, etc., manufactured by Shimadzu Corporation).

The amount of the filler contained in the heat-resistant layer is preferably 20% by weight to 90% by weight, and more preferably 40% by weight to 80% by weight, relative to the total weight of the heat-resistant layer. When the amount of the filler contained in the heat-resistant layer falls within the above range, the resulting heat-resistant layer has sufficient ion permeability.

The heat-resistant layer has an air permeability of preferably not more than 400 sec/100 mL, and more preferably not more than 200 sec/100 mL, in terms of a Gurley value.

### [Method of Producing Heat-Resistant Layer]

In an embodiment of the present invention, the heat-resistant layer can be formed simultaneously with formation of the mixed layer. Namely, a method of producing the heat-resistant layer is the same as the method of producing the mixed layer.

### [Physical Properties of Nonaqueous Electrolyte Secondary Battery Separator]

The nonaqueous electrolyte secondary battery separator in accordance with an embodiment of the present invention has a thickness of preferably 5.0 μm to 45 μm, and more preferably 6 μm to 25 μm.

The separator has an air permeability of preferably not more than 500 sec/100 mL, and more preferably not more than 300 sec/100 mL, in terms of a Gurley value. When the air permeability falls within the above range, it can be said that the separator has sufficient ion permeability.

The separator may include another porous layer, which is different from the residual porous base material, the mixed layer, and the heat-resistant layer, as necessary, provided that the object of the present invention is not prevented from being attained. Examples of the another porous layer include publicly known porous layers such as another heat-resistant layer, an adhesive layer, and a protective layer.

### EMBODIMENT 2

### Nonaqueous Electrolyte Secondary Battery Member

### EMBODIMENT 3

### Nonaqueous Electrolyte Secondary Battery

A nonaqueous electrolyte secondary battery member in accordance with Embodiment 2 of the present invention includes a positive electrode, a nonaqueous electrolyte secondary battery separator in accordance with Embodiment 1 of the present invention, and a negative electrode which are disposed in this order.

A nonaqueous electrolyte secondary battery in accordance with Embodiment 3 of the present invention includes a nonaqueous electrolyte secondary battery separator in accordance with Embodiment 1 of the present invention.

The nonaqueous electrolyte secondary battery in accordance with Embodiment 3 of the present invention can be, for example, a nonaqueous secondary battery which achieves an electromotive force through doping with and dedoping of lithium. The nonaqueous electrolyte secondary battery can include a nonaqueous electrolyte secondary battery member which includes a positive electrode, the nonaqueous electrolyte secondary battery separator in accordance with Embodiment 1 of the present invention, and a negative electrode that are formed in this order. Note that constituent elements, other than the nonaqueous electrolyte secondary battery separator, of the nonaqueous electrolyte secondary battery are not limited to those described below.

The nonaqueous electrolyte secondary battery in accordance with Embodiment 3 of the present invention is typically structured such that a battery element is enclosed in an exterior member, the battery element including (i) a structure in which the negative electrode and the positive electrode face each other with the nonaqueous electrolyte secondary battery separator in accordance with Embodiment 1 of the present invention therebetween and (ii) an electrolyte with which the structure is impregnated. The nonaqueous electrolyte secondary battery is particularly preferably a lithium ion secondary battery. Note that the doping means occlusion, support, adsorption, or insertion, and means a phenomenon in which lithium ions enter an active material of an electrode such as a positive electrode.

The nonaqueous electrolyte secondary battery member in accordance with Embodiment 2 of the present invention includes the separator in accordance with Embodiment 1 of the present invention. Therefore, the nonaqueous electrolyte secondary battery member in accordance with Embodiment 2 of the present invention has the effect of having excellent heat resistance and also excellent voltage withstand characteristics. The nonaqueous electrolyte secondary battery in accordance with Embodiment 3 of the present invention includes the separator in accordance with Embodiment 1 of the present invention. Therefore, the nonaqueous electrolyte secondary battery in accordance with Embodiment 3 of the present invention has the effect of having excellent heat resistance and also excellent voltage withstand characteristics.

### <Positive Electrode>

The positive electrode in each of the nonaqueous electrolyte secondary battery member in accordance with an embodiment of the present invention and the nonaqueous electrolyte secondary battery in accordance with an embodiment of the present invention is not limited to any particular one, provided that the positive electrode is one that is generally used as a positive electrode of a nonaqueous electrolyte secondary battery. The positive electrode can be, for example, a positive electrode sheet having a structure in which an active material layer, containing a positive electrode active material and a binding agent, is formed on a positive electrode current collector. The active material layer may further contain an electrically conductive agent.

Examples of the positive electrode active material include materials each capable of being doped with and dedoped of lithium ions. Specific examples of the materials include lithium complex oxides each containing at least one transition metal such as V, Mn, Fe, Co, or Ni.

Examples of the electrically conductive agent include carbonaceous materials such as natural graphite, artificial graphite, cokes, carbon black, pyrolytic carbons, carbon fiber, and fired products of organic polymer compounds. As the electrically conductive agent, only one type of electrically conductive agent may be used or two or more types of electrically conductive agents may be used in combination.

Examples of the binding agent include: fluorine-based resins such as polyvinylidene fluoride (PVDF); acrylic resin; and styrene butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet includes: a method which involves pressure-molding the positive electrode active material, the electrically conductive agent, and the binding agent on the positive electrode current collector; and a method which involves (i) forming the positive electrode active material, the electrically conductive agent, and the binding agent into a paste with use of an appropriate organic solvent, (ii) coating the positive electrode current collector with the paste, and (iii) drying and then pressurizing the paste so that the paste is fixed to the positive electrode current collector.

### <Negative Electrode>

The negative electrode in each of the nonaqueous electrolyte secondary battery member in accordance with an embodiment of the present invention and the nonaqueous electrolyte secondary battery in accordance with an embodiment of the present invention is not limited to any particular one, provided that the negative electrode is one that is generally used as a negative electrode of a nonaqueous electrolyte secondary battery. The negative electrode can be, for example, a negative electrode sheet having a structure in which an active material layer, containing a negative electrode active material and a binding agent, is formed on a negative electrode current collector. The active material layer may further contain an electrically conductive agent.

Examples of the negative electrode active material include materials each capable of being doped with and dedoped of lithium ions, lithium metal, and lithium alloy. Examples of the materials include carbonaceous materials. Examples of the carbonaceous materials include natural graphite, artificial graphite, cokes, carbon black, and pyrolytic carbons.

Examples of the negative electrode current collector include Cu, Ni, and stainless steel. Cu is more preferable because Cu is not easily alloyed with lithium particularly in a lithium-ion secondary battery and is easily processed into a thin film.

Examples of a method of producing the negative electrode sheet include: a method which involves pressure-molding the negative electrode active material on the negative electrode current collector; and a method which involves (i) forming the negative electrode active material into a paste with use of an appropriate organic solvent, (ii) coating the negative electrode current collector with the paste, and (iii) drying and then pressurizing the paste so that the paste is firmly fixed to the negative electrode current collector. The paste preferably contains the electrically conductive agent and the binding agent.

### <Nonaqueous Electrolyte>

The nonaqueous electrolyte in the nonaqueous electrolyte secondary battery in accordance with an embodiment of the present invention is not limited to any particular one, provided that the nonaqueous electrolyte is one that is generally used for a nonaqueous electrolyte secondary battery. For example, a nonaqueous electrolyte obtained by dissolving a lithium salt in an organic solvent can be used. Examples of the lithium salt include LiClO₄, LiPF₆, LiAsF₆, LiSbF₆, LiBF₄, LiCF₃SO₃, LiN(CF₃SO₂)₂, LiC(CF₃SO₂)₃, Li₂BioClio, lower aliphatic carboxylic acid lithium salt, and LiAlCl₄. As the lithium salt, only one type of lithium salt may be used or two or more types of lithium salts may be used in combination.

Examples of the organic solvent contained in the nonaqueous electrolyte include carbonates, ethers, esters, nitriles, amides, carbamates, sulfur-containing compounds, and fluorine-containing organic solvents each obtained by introducing a fluorine group into any of these organic solvents. As the organic solvent, only one type of organic solvent may be used or two or more types of organic solvents may be used in combination.

### EXAMPLES

The following description will discuss embodiments of the present invention in greater detail with reference to Examples and Comparative Examples. Note, however, that the present invention is not limited to Examples below.

### [Methods of Measuring Various Physical Properties]

In Examples and Comparative Examples, various physical properties were measured by the following methods.

### [Weight Per Unit Area]

A separator was cut out into a square piece measuring 8 cm on each side, and the square piece was used as a sample. The weight Wₐ [g] of the sample was measured. Further, a peeling tape was affixed to a surface of the sample on which a heat-resistant layer was formed, and then peeled off so that the heat-resistant layer was peeled off from the separator. In this manner, a laminated body which was constituted by a residual porous base material and a mixed layer was obtained. The weight W_{b} [g] of the laminated body was measured. Values of the measured Wₐ and W_{b} were used to calculate the weight per unit area of the heat-resistant layer in accordance with expression (1) below.

The weight per unit area of the heat-resistant layer=(Wₐ−W_{b})/(0.08×0.08) expression (1)

### [Air Permeability]

The air permeability (Gurley value) of the separator was measured in accordance with JIS P8117.

### [Attenuated Total Reflection Infrared Spectroscopy (ATR-IR)]

With respect to the separator produced in each of Examples and Comparative Examples, a “peak intensity ratio” was calculated by a method including the following steps (I) to (III).

(I) The step of obtaining an IR spectrum by carrying out attenuated total reflection infrared spectroscopy with respect to a measurement target under <Measurement conditions> below with use of a reflection type infrared analyzer (manufactured by Agilent Technologies, Inc., product name: Cary 660 FTIR). The measurement target was, out of surfaces of a porous base material, a surface which was opposite to a surface to which a coating solution containing a heat-resistant resin had been applied (that is, an opposite surface of the nonaqueous electrolyte secondary battery separator).

### <Measurement Conditions>

Measurement was carried out by an ATR method with use of diamond as a prism in a nitrogen atmosphere.

(II) The step of obtaining a peak intensity (A) of a peak indicating the heat-resistant resin and a peak intensity (B) of a peak indicating a polyolefin-based resin from the IR spectrum obtained in the step (I).

(III) The step of calculating a “peak intensity ratio” with use of (A) and (B) obtained in the step (II) on the basis of the following expression (2).

The “peak intensity ratio”=(A)/(B) expression (2)

Note that, as described later, in the separator produced in each of Examples and Comparative Examples, an aramid resin was used as the heat-resistant resin and polyethylene was used as the polyolefin-based resin.

In the step (III), a peak which was obtained in the step (II) and which is present in a wave number range of 1,620 cm⁻¹ to 1,700 cm⁻¹ is a peak indicating the heat-resistant resin. Thus, the intensity of the peak present in the wave number range of 1,620 cm⁻¹ to 1,700 cm⁻¹ was measured and regarded as the above (A). A peak present in a wave number range of 1,400 cm⁻¹ to 1,500 cm⁻¹ is a peak indicating the polyolefin-based resin. Thus, the intensity of the peak present in the wave number range of 1,400 cm⁻¹ to 1,500 cm⁻¹ was measured and regarded as the above (B).

### [Withstand Voltage Limit]

The separator was placed between a probe and a base of a withstand voltage tester (TS9200, manufactured by Kikusui Electronics Corporation) so that the outermost surface of the separator, which was located on a side on which the surface of the porous base material to which the coating solution containing the heat-resistant resin had been applied during production of the separator was present, and the probe were in contact with each other. Next, a voltage was applied between the probe and the base, and the voltage was increased at a rate of 25 V/sec. In so doing, a value of the voltage at a time of occurrence of a short circuit was recorded as a “withstand voltage limit”.

### [Thermal Shrinkage Rate]

The separator obtained in each of Examples and Comparative Examples was cut out into a square piece measuring 8 cm in length of a width in an MD×8 cm in length of a width in a TD. A square frame measuring 6 cm in length of a width in the MD×6 cm in length of a width in the TD was drawn 1 cm inward from an edge on each side of the above square piece. After A5-size paper (copy paper) was folded in two, the cut-out separator was sandwiched in the paper, and the paper was closed with use of a stapler to obtain a sample.

The sample was placed inside an oven inside which the temperature was set to 200° C., and allowed to stand still for 1 hour. Thereafter, the sample was taken out from the oven, and the length DMD [cm] of the width in the MD of the square frame drawn in the heated sample and the length DTD [cm] of the width in the TD of the square frame drawn in the heated sample were measured. Values of the measured DMD and DTD were used to calculate a thermal shrinkage rate in the MD and the TD when the separator was heated at 200° C., in accordance with expressions (3) and (4).

The thermal shrinkage rate in the MD [%]={(6−D_{MD})/6}×100 expression (3)

The thermal shrinkage rate in the TD [%]={(6−D_{TD})/6}×100 expression (4)

### Production Example 1

### Preparation of Aramid Resin

Poly(paraphenylene terephthalamide), which was one type of aramid resin, was synthesized by the following method. As a vessel for the synthesis, used was a 3-L separable flask having a stirring blade, a thermometer, a nitrogen inlet pipe, and a powder addition port. The separable flask was sufficiently dried, and then 2,200 g of NMP was introduced into the separable flask. To the separable flask, 151.07 g of a calcium chloride powder was added. The temperature of a mixture of the NMP and the calcium chloride powder was raised to 100° C. so that the calcium chloride powder was completely dissolved. In this manner, a solution A was obtained. The calcium chloride powder was previously vacuum-dried at 200° C. for 2 hours.

Next, the temperature of the solution A was returned to room temperature. To the solution A, 68.23 g of paraphenylenediamine was added, and then was completely dissolved to obtain a solution B. While the temperature of the solution B was maintained at 20° C.±2° C., 124.97 g of terephthalic acid dichloride was added to the solution B in 4 separate portions at approximately 10-minute intervals to obtain a solution C. Thereafter, the solution C was matured for 1 hour in a state where the temperature of the solution C was maintained at 20° C.±2° C., while the solution C was stirred at 150 rpm. As a result, an aramid polymerization solution containing 6% by weight of poly(paraphenylene terephthalamide) was obtained.

### Production Example 2

### Preparation of Coating Solution (1)

First, 100 g of the aramid polymerization solution was weighed and introduced into a flask. Then, 6.0 g of alumina A (average particle diameter: 13 nm) was added to obtain a dispersion liquid A1. In the dispersion liquid A1, the poly(paraphenylene terephthalamide) and the alumina A were contained at a weight ratio of 1:1. Next, NMP was added to the dispersion liquid A1 so that a solid content became 4.5% by weight. The dispersion liquid A1 to which the NMP had been added was stirred for 240 minutes to obtain a dispersion liquid B1. Note that the “solid content” here refers to the total weight of the poly(paraphenylene terephthalamide) and the alumina A. Next, 0.73 g of calcium carbonate was added to the dispersion liquid B1. The dispersion liquid B1 to which the calcium carbonate had been added was stirred for 240 minutes so as to be neutralized. A coating solution (1) in a slurry form was prepared by defoaming the neutralized dispersion liquid B1 under reduced pressure.

### Production Example 3

### Preparation of Coating Solution (2)

First, 100 g of the aramid polymerization solution was weighed and introduced into a flask. Then, 6.0 g of alumina A (average particle diameter: 13 nm) and 6.0 g of alumina B (average particle diameter: 640 nm) were added to obtain a dispersion liquid A2. In the dispersion liquid A2, the poly(paraphenylene terephthalamide), the alumina A, and the alumina B were contained at a weight ratio of 1:1:1. Next, NMP was added to the dispersion liquid A2 so that a solid content became 6.0% by weight. The dispersion liquid A2 to which the NMP had been added was stirred for 240 minutes to obtain a dispersion liquid B2. Note that the “solid content” here refers to the total weight of the poly(paraphenylene terephthalamide), the alumina A, and the alumina B. Next, 0.73 g of calcium carbonate was added to the dispersion liquid B2. The dispersion liquid B2 to which the calcium carbonate had been added was stirred for 240 minutes so as to be neutralized. A coating solution (2) in a slurry form was prepared by defoaming the neutralized dispersion liquid B2 under reduced pressure.

### Example 1

As the porous base material, a polyolefin porous film (thickness: 10.5 μm, air permeability: 92 sec/100 mL, weight per unit area: 5.40 g/m²) made of polyethylene was used. The coating solution (1) was applied to one surface of the porous base material with use of a high-pressure bar under the conditions that a clearance was 0.05 mm and a coating speed was 20 mm/min, while a working load of 327 N/m per width of a coating bar was applied to the porous base material. As a result, a coated material was obtained. The obtained coated material was allowed to stand still in an atmosphere at 50° C. and at a relative humidity of 70% for 1 minute so that the poly(paraphenylene terephthalamide) was deposited. Next, the coated material in which the poly(paraphenylene terephthalamide) was deposited was immersed in ion-exchange water so that the calcium chloride and the solvent were removed from the coated material. Subsequently, the coated material from which the calcium chloride and the solvent had been removed was dried at 80° C. to obtain a nonaqueous electrolyte secondary battery separator (1).

### Example 2

A nonaqueous electrolyte secondary battery separator (2) was obtained by the same method as in Example 1, except the following (i) and (ii).
(i) The coating solution (2) was used in place of the coating solution (1).
(ii) The porous base material was coated with the coating solution with use of a high-pressure bar under the conditions that a clearance was 0.06 mm and a coating speed was 20 mm/min, while a working load of 327 N/m per width of a coating bar was applied to the porous base material.

### Example 3

A nonaqueous electrolyte secondary battery separator (3) was obtained by the same method as in Example 1, except the following (iii) and (iv).
(iii) The coating solution (2) was used in place of the coating solution (1).
(iv) The porous base material was coated with the coating solution with use of a high-pressure bar under the conditions that a clearance was 0.08 mm and a coating speed was 20 mm/min, while a working load of 327 N/m per width of a coating bar was applied to the porous base material.

### Comparative Example 1

A nonaqueous electrolyte secondary battery separator (4) was obtained by the same method as in Example 1, except the following (v) to (vii).
(v) As the porous base material, a polyolefin porous film (thickness: 10.8 μm, air permeability: 91 sec/100 mL, weight per unit area: 5.52 g/m²) made of polyethylene was used.
(vi) The porous base material was coated with the coating solution with use of an ordinary bar under the conditions that a clearance was 0.07 mm and a coating speed was 20 mm/min, while a working load of 94 N/m per width of a coating bar was applied to the porous base material.
(vii) The coating was carried out while a surface of the porous base material that was opposite to the surface to which the coating solution was applied was impregnated with NMP.

### [Comparative Example 2]

A nonaqueous electrolyte secondary battery separator (5) was obtained by the same method as in Example 1, except the following (viii) and (ix).
(viii) As the porous base material, a polyolefin porous film (thickness: 10.8 μm, air permeability: 94 sec/100 mL, weight per unit area: 5.56 g/m²) made of polyethylene was used.
(ix) The porous base material was coated with the coating solution with use of a bar coater for manual coating under the conditions that a clearance was 0.05 mm and a coating speed was 5 mm/min, while a working load was substantially not applied to the porous base material.

### [Results]

The physical property values etc. of the nonaqueous electrolyte secondary battery separators (1) to (5) produced in Examples 1 to 3 and Comparative Examples 1 and 2 were measured by the above-described methods. Table 1 below shows the results.

TABLE 1

| | Heat- | | | | | |
|---|---|---|---|---|---|---|
| | resistant | Nonaqueous electrolyte | | | | |
| | layer | secondary battery separator | | | | |
| | Weight | Air | | Withstand | Thermal | |
| | per | permeability | Peak | voltage | shrinkage rate | |
| | unit area | [sec/ | intensity | limit | at 200° C. [%] | |
| | [g/m²] | 100 mL] | ratio | [kV] | MD | TD |
| Example 1 | 1.5 | 167 | 0.038 | 1.94 | 62.8 | 89.3 |
| Example 2 | 5.4 | 267 | 0.029 | 2.01 | 98.7 | 99.2 |
| Example 3 | 6.4 | 326 | 0.030 | 1.97 | 98.8 | 98.9 |
| Com- | 1.6 | 163 | 0.007 | 1.55 | 43.6 | 84.9 |
| parative | | | | | | |
| Example 1 | | | | | | |
| Com- | 1.5 | 168 | 0.015 | 1.67 | 53.1 | 69.7 |
| parative | | | | | | |
| Example 2 | | | | | | |

As shown in Table 1, the “peak intensity ratio” on the opposite surface of each of the nonaqueous electrolyte secondary battery separators (1) to (3) produced in Examples 1 to 3 is not less than 0.02. On the contrary, the “peak intensity ratio” on the opposite surface of each of the nonaqueous electrolyte secondary battery separators (4) and (5) produced in Comparative Examples 1 and 2 is less than 0.02. Further, it was found that, since the nonaqueous electrolyte secondary battery separators (1) to (3) were higher in value of the thermal shrinkage rate at 200° C., the nonaqueous electrolyte secondary battery separators (1) to (3) had more excellent heat resistance than the nonaqueous electrolyte secondary battery separators (4) and (5). Moreover, it was found that, since the nonaqueous electrolyte secondary battery separators (1) to (3) were higher in value of the withstand voltage limit, the nonaqueous electrolyte secondary battery separators (1) to (3) had also more excellent voltage withstand characteristics than the nonaqueous electrolyte secondary battery separators (4) and (5).

As such, it was found that a nonaqueous electrolyte secondary battery separator in accordance with an embodiment of the present invention had excellent heat resistance and also excellent voltage withstand characteristics, due to having a “peak intensity ratio” of not less than 0.02 on the opposite surface of the nonaqueous electrolyte secondary battery separator.

### INDUSTRIAL APPLICABILITY

A nonaqueous electrolyte secondary battery separator in accordance with an embodiment of the present invention can be suitably used even in an environment in which high heat resistance is required.

1. A nonaqueous electrolyte secondary battery separator comprising
a mixed layer which contains a heat-resistant resin and a porous base material that includes a porous film containing a polyolefin-based resin as a main component, when attenuated total reflection infrared spectroscopy (ATR-IR) is carried out with respect to an opposite surface of the nonaqueous electrolyte secondary battery separator, a peak indicating the polyolefin-based resin and a peak indicating the heat-resistant resin being observed, and a ratio (A/B) between an intensity (A) of the peak indicating the heat-resistant resin and an intensity (B) of the peak indicating the polyolefin-based resin being not less than 0.02.

2. The nonaqueous electrolyte secondary battery separator as set forth in claim 1, wherein:
the peak indicating the heat-resistant resin is a peak present in 1,620 cm⁻¹ to 1,700 cm⁻¹; and
the peak indicating the polyolefin-based resin is a peak present in 1,400 cm⁻¹ to 1,500 cm⁻¹.

3. The nonaqueous electrolyte secondary battery separator as set forth in claim 1, wherein a heat-resistant layer which contains the heat-resistant resin is formed on the mixed layer.

4. The nonaqueous electrolyte secondary battery separator as set forth in claim 3, wherein the heat-resistant layer further contains a filler.

5. The nonaqueous electrolyte secondary battery separator as set forth in claim 4, wherein an amount of the filler contained in the heat-resistant layer is not less than 20% by weight and not more than 90% by weight, relative to a total weight of the heat-resistant layer.

6. The nonaqueous electrolyte secondary battery separator as set forth in claim 1, wherein an air permeability of the nonaqueous electrolyte secondary battery separator is not more than 500 sec/100 mL.

7. The nonaqueous electrolyte secondary battery separator as set forth in claim 1, wherein the heat-resistant resin is an aramid resin.

8. A nonaqueous electrolyte secondary battery member comprising:
a positive electrode;
a nonaqueous electrolyte secondary battery separator recited in claim 1; and
a negative electrode,
the positive electrode, the nonaqueous electrolyte secondary battery separator, and the negative electrode being disposed in this order.

9. A nonaqueous electrolyte secondary battery comprising a nonaqueous electrolyte secondary battery separator recited in claim 1.
